(19) United States
(12) Patent Application Publication
(10) Pub. No.: US 2015/0127371 A1
(43) Pub. Date: May 7, 2015

(54) Connected Tracker for Oral Health Implements

(71) Applicant: Beam Technologies INC, Columbus, OH (US)

(72) Inventors: Daniel E. Dykes, Columbus, OH (US); Alexander D. Curry, Columbus, OH (US); Alex X. Frommeyer, Columbus, OH (US)

(21) Appl. No.: 14/535,306

(22) Filed: Nov. 6, 2014

Related U.S. Application Data
(60) Provisional application No. 61/900,433, filed on Nov. 6, 2013.

(51) Int. Cl. G06F 19/00

(52) U.S. Cl. CPC G06F 19/3418
USPC 705/2

(57) ABSTRACT

A connected activity tracker for oral health implements is provided for use during oral health care activities carried out daily by a user. A connected activity tracker is provided including an activity sensor that provides activity data for various oral health implements. The connected activity tracker is attached to an oral health implement such that the connected activity tracker is tracking the activity of said oral health implement. Further, the connected activity tracker comprises a transceiver that provides a means for transferring the data from the connected activity tracker to an external medium for viewing and manipulation. Further still, the connected activity tracker is comprised in a system including a data transfer medium (i.e. “smartphone”) and the Cloud, which allows for data transfer between multiple external mediums from the connected activity tracker. The system further allows for passive participation in social games with awards and incentives. The system and connected activity tracker further provide for active participation in oral health games to encourage proper oral health.

### CROSS-REFERENCE TO RELATED APPLICATIONS

This application claims priority to U.S. Provisional Application No. 61/900,433 filed on Nov. 6, 2013.

### BACKGROUND

The subject embodiments relate to connected trackers for oral health care implements and systems, particularly relating to improved trackers utilizing new technologies for the dental field. In particular, the embodiments relate to trackers with sensors and user identification capabilities.

Dental plaque is a biofilm that forms naturally on teeth between brushing and dental visits. Dental plaque can be a precursor to more severe oral health problems including: dental caries, tooth decay, gingivitis, and chronic periodontitis. The occurrence of dental caries is one of the largest health epidemics in the world and is the most common chronic childhood disease in the United States. Likewise, gingivitis and dental calculus are two of the most common systemic diseases of the body. It is desirable to more effectively remove dental plaque early stage as a preventive measure against more serious disease states. The most common preventive measure implemented to control the formation of dental plaque is the toothbrush.

Further still, clinical dental visits with dental practitioners are a method of prevention and detection of dental plaque. Regular dental visits are recommended to occur every six months. Regular toothbrush replacement is recommended to occur every three months according to dental practitioners. The lack of adherence to these recommendations and lack of brushing compliance is often a contributing factor to the development of dental plaque and its associated complications. Regular replacement of toothbrushes is often disregarded by users and cause issues as bristles become deformed and are no longer providing the proper cleaning.

Additionally, the introduction of data logging in toothbrushes presents unique challenges to the existing toothbrush market. It is common for more expensive powered toothbrush bases to be used by multiple users that interchange heads depending on the user. This provides the challenge of identifying the user that is currently using the toothbrush base and logging data.

Consequently, consumers and medical professionals are in need of a toothbrush tracker with sensors to monitor various health statistics through course of a normal daily activity. Moreover, consumers and medical professionals are in need daily monitoring to facilitate predicative health models. Further, consumers are in need of incentives for completing daily routines to encourage proper preventative health. Consequently, a method for identifying multiple users of the same toothbrush handle is desirable for consumers.

### SUMMARY OF EMBODIMENTS

The embodiments described herein meet the objectives stated in the previous section, and provide an improved tracker for toothbrushes and systems with various sensors for the detection of various health statistics and conditions. A connected activity tracker is provided including an activity sensor that provides activity data for various oral health implements.

The connected activity tracker is attached to an oral health implement such that the connected activity tracker is tracking the activity of said oral health implement. Further, the connected activity tracker comprises a transceiver that provides a means for transferring the data from the connected activity tracker to an external medium for viewing and manipulation.

Further still, the connected activity tracker is comprised in a system including a data transfer medium (i.e. “smartphone”) and the Cloud, which allows for data transfer between multiple external mediums from the connected activity tracker. The system further allows for passive participation in social games with awards and incentives. The system and connected activity tracker further provide for active participation in oral health games to encourage proper oral health.

Accordingly, several advantages are to provide a tracker for toothbrushes, to provide an activity sensor that provides activity data for various oral health implements, to provide transmission of data from the tracker to either a data transfer medium or the Cloud, and to provide user identification to the tracker. Still further advantages will become apparent from a study of the following descriptions and accompanying drawings.

### BRIEF DESCRIPTION OF THE DRAWINGS

The drawings and embodiments described herein are illustrative of multiple alternative structures, aspects, and features of the embodiments described and claimed herein, and they are not be understood as limiting the scope of the embodiments. It will be further understood that the drawing figures described and provided herein are not to scale, and that the embodiments are not limited to the precise arrangements and instrumentalities shown.

FIG. 1 is a perspective view of a tracker attached to a toothbrush, according to multiple embodiments and alternatives.

### MULTIPLE EMBODIMENTS AND ALTERNATIVES

According to multiple embodiments and alternatives herein, a connected tracker for oral health implements and applications thereof shall be discussed in the present section.

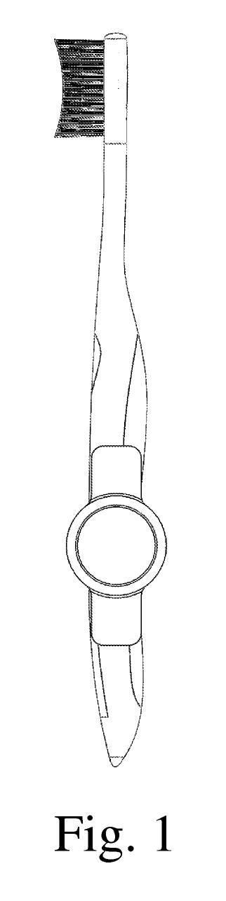

FIG. 1 shows a connected activity tracker. A connected activity tracker is used to capture the movement of an oral health implement or the presence of its user, thus capturing the activity of the oral health implement. The connected activity tracker is attached to the oral health implement such that the connected activity tracker moves with the oral health implement and has the same relative motion. The activity of the oral health implement is related to the usage of the oral health implement in terms of frequency and duration. Furthermore, the activity of the oral health implement is defined by quality of use, such as the brushing quality of a toothbrush.

In some embodiments, the connected activity tracker is attached to an oral health implement that is a toothbrush. A toothbrush is an oral health care implement used for the cleaning of teeth and gingiva, more commonly referred to as gums. The toothbrush is operated in the oral cavity of a human being characterized as the first portion of the alimentary canal that receives food and saliva, and containing a mucous membrane epithelium lining referred to as the oral mucosa. The oral cavity is further characterized as having alveolar arches typically containing teeth, which are either natural, synthetic, or a combination thereof, and used primarily for the preparatory chewing of food for digestion.

A toothbrush comprises a brush head consisting of a plurality of bristles arranged into compact clusters, often referred to as tufts, mounted onto the brush head. Accordingly, the tufts are often mounted in an intentional pattern to facilitate cleaning of teeth and gums. A toothbrush further comprises a handle that extends proximally from the brush head and is used for grasping and movement of the toothbrush. The bristles of the toothbrush are commonly manufactured from either a natural material, synthetic material, or a combination thereof. One example of a natural bristle material is animal hair. An example of a typical synthetic bristle material is Nylon.

Inherently, a toothbrush has an associated motion when in use, which is characterized as either manually driven (i.e. manual toothbrush) or electromechanically driven (i.e. powered toothbrush). A manually driven motion is regarded as a motion generated by the user by his/her own power. Conversely, an electromechanically driven motion is characterized as a motion generated by electrical power which is converted to mechanical power used to create the specified electromechanically driven motion. In some embodiments, the electromechanically driven motion is a side-to-side oscillating motion also referred to as vibratory motion. Often, the vibratory motion is generated by an electric motor with an eccentric weight on the drive shaft of the electric motor. In other instances, the vibratory motion is generated by an electrically conductive coil around the outside of a magnetic mass, such that when an alternating current is applied to the coil, the magnetic mass oscillates causing vibration of the toothbrush. In other embodiments, the electromechanically driven motion is a rotation-oscillation motion wherein the head rotates either clockwise or counter-clockwise and then rotates in the opposite direction of the first rotation. Additionally, a portion of the brush head may move in a translational motion to provide additional cleaning.

In some embodiments, the connected activity tracker is attached to an oral health implement that is a flosser. A flosser is an oral health care implement used for the removal of food and dental plaque from teeth, especially between teeth and other places a toothbrush cannot effectively clean. A flosser comprises a flosser head having two parallel protrusions with space between them such that a length of dental floss can be placed between the two protrusions. The dental floss is, most often, held taut by the two protrusions to facilitate proper cleaning.

In some embodiments, the connected activity tracker is attached to an oral health implement that is a gum massager. A gum massager is an oral health care implement used for the stimulation of gums to promote better oral health. A gum massager comprises a massager head shaped to facilitate effective stimulation of gums. The massager head is often in the form of a rubber tip.

In some embodiments, the connected activity tracker is attached to an oral health implement that is a tongue cleaner, which is used for cleaning bacteria, food debris, fungi, and dead cells from the surface of the tongue. A tongue cleaner comprises a cleaning head on the distal end of a handle having a distal end, middle portion, and proximal end. The cleaning head often comprises a plurality of small ridges oriented perpendicular to the long axis of the handle. The ridges are moved along the surface of the tongue to scrap off unwanted matter.

In some embodiments, the connected activity tracker is attached to an oral health implement that is an interdental brush used for cleaning between teeth. An interdental brush comprises a brush head that comprises the small brush sized to fit between a user's teeth. The brush head is located at the distal end of a handle, wherein the handle has a distal end, middle portion, and proximal end. An interdental brush is also commonly referred to as an interproximal brush or a proxy brush.

In some embodiments, the connected activity tracker is attached to an oral health implement that is a dental floss dispenser. A dental floss dispenser provides a housing that contains dental floss, most often on a spool. The dental floss is pulled out of the housing and cut to a desired length using a sharp edge.

The connected activity tracker comprises a data processing unit having a storage medium that is configured to store data and at least one processor that is configured to process data. Accordingly, the data processing unit is chosen from the group microprocessor, microcontroller, field programmable gate array (FPGA), digital signal processing unit (DSP), application specific integrated circuit (ASIC), programmable logic, and combinations thereof.

Moreover, the storage medium of the data processing unit is comprised of volatile memory and non-volatile memory, wherein volatile memory is used for short-term storage and processing, and non-volatile memory is used for long-term storage. Accordingly, volatile memory is chosen from the group random-access memory (RAM), dynamic random-access memory (DRAM), double data rate synchronous dynamic random-access memory (DDR SDRAM), static random-access memory (SRAM), thyristor random-access memory (T-RAM), zero-capacitor random-access memory (Z-RAM), and twin transistor random-access memory (TTRAM). Non-volatile memory is chosen from the group read-only memory (ROM), programmable read-only memory (PROM), erasable programmable read-only memory (EPROM), electrically erasable programmable read-only memory (EEPROM), flash memory, ferroelectric random-access memory (FeRAM), magnetoresistive random-access memory (MRAM), phase-change memory (PRAM), conductive-bridging random-access memory (CBRAM), silicon-oxide-nitride-oxide-silicon memory (SONOS), resistive random-access memory (RRAM), racetrack memory, nano-random-access memory (NRAM), and Millipede memory.

The processor of the data processing unit is chosen from the group microprocessor and micro controller.

The connected activity tracker further comprises a transceiver that is configured to transmit and receive data. The data is packaged as at least one signal and transmitted to another medium. The transceiver is chosen from the group consisting of universal serial bus (USB), serial port, wired Ethernet port, radio frequency, microwave communication, infrared short-range communication, near field communication, Bluetooth, Wi-Fi, and any combination thereof.

In some embodiments, the connected activity tracker further comprises an activity sensor. The activity sensor is at least one accelerometer, wherein the activity sensor measures the acceleration of the inertial reference frame relative to itself. The inertial reference frame is defined as the reference frame where an object is in free-fall (i.e. not resisting gravity). Additionally, in some embodiments, the accelerometer is a microelectromechanical system (MEMS) comprised of a cantilever beam with a proof mass where damping results from a residual gas sealed inside the accelerometer. Piezoelectric material is often used to convert the mechanical motion into an electrical signal.

Optionally, the activity sensor is at least one gyroscope, wherein the activity sensor measures orientation based on the principle of conservation of angular momentum. Alternatively, the activity sensor measures activity based on the physical principle that a vibrating object tends to continue vibrating in the same plane as its support rotates, otherwise known as a vibrating structure gyroscope. In further options, the gyroscope is a microelectromechanical system. Accordingly, the microelectromechanical system that is a vibrating structure gyroscope utilizes a mechanism chosen from the group consisting of piezoelectric gyroscope, which uses a piezoelectric material to induce vibration; wine glass resonator, which uses a hemisphere that is driven to resonance; tuning fork gyroscope, which uses two tests masses that are driven to resonance; vibrating wheel gyroscope, which uses a wheel that is driven a fraction of a full turn about its axis; and any combination thereof.

Optionally, the activity sensor is at least one accelerometer and at least one gyroscope, wherein the accelerometer and the gyroscope operate in conjunction to produce measurement of the full six degrees of freedom. The full six degrees of freedom are characterized as forward/backward, up/down, left/right, pitch, yaw, and roll.

Accordingly, in some embodiments, the data processing unit and the activity sensor operate in conjunction to provide means for determining position of the oral health implement within the oral cavity. The activity sensor detects the orientation of the toothbrush and transmits a signal to the data processing unit. The processor of the data processing unit operates in conjunction with the storage medium to compare the stored orientation data to previously stored orientation data that correlates to certain positions within the oral cavity. Optionally, the previously stored orientation data that correlates to certain positions within the oral cavity is collected by placing the oral health implement at various predetermined positions within the oral cavity, wherein the activity sensor output is stored at each predetermined position, thus creating correlation data for comparison.

Optionally, the activity sensor is a capacitive sensor. One type of capacitive sensor is a capacitive sensor that works with a frequency change, alternatively referred to as a frequency change capacitive sensor. Optionally, another type of capacitive sensor is a capacitive sensor that works with a capacitive voltage divider, alternatively referred to as a voltage divider capacitive sensor. Both types of capacitive sensors detect the added capacitance of the human body, thus indicating the human body is in contact with the oral health implement.

The frequency change capacitive sensor comprises a sensor surface, a resistor-capacitor (RC) circuit, and an RC oscillator, wherein the capacitance of the human body introduced by the sensor surface is a parallel capacitance in the RC circuit such that, when the capacitance of the human body is present, the overall capacitance of the RC circuit is altered. The RC oscillator operates at a set frequency controlled by the capacitance of the RC circuit. The sensor surface comes into proximity of the human body, and, consequently, the capacitance of the human body is introduced to the RC circuit by a connection between the sensor surface and the RC circuit such that the capacitance of the human body is a parallel capacitance to the RC circuit. The change in overall capacitance of the RC circuit changes the frequency of the RC oscillator, thus, indicating the human body is in proximity to the sensor surface.

The voltage divider capacitive sensor comprises a sensor surface, which provides an analog input; a reference voltage; an analog-to-digital converter (A/DC); and an A/DC capacitor. The A/DC is internally driven to the reference voltage such that the A/DC capacitor is fully charged, and the analog input of the sensor surface is internally grounded such that the sensor surface is fully discharged. Next, the analog input of the sensor surface is internally disconnected from the ground and is internally connected to the A/DC such that the A/DC capacitor will discharge at least a portion of its charge to the sensor surface in order to equal the voltages of the sensor surface and the A/DC capacitor. If the human body is in proximity to the sensor surface, the sensor will appear to have a larger capacitance. Said larger capacitance results in a many time smaller steady-state voltage between the A/DC capacitor and the sensor as compared to the condition when the sensor is in its normal, low capacitance state. The A/DC may measure the analog input and compare it to a threshold to determine if the sensor surface is in proximity to the human body. The voltage provided to the A/DC will decrease in a manner indicative of the human body's proximity to the sensor surface. In some embodiments, the decrease in a manner indicative of the human body's proximity to the sensor surface is significant.

In some embodiments, the connected tracker further comprises an oximetry sensor. Optionally, the oximetry sensor is a transmissive pulse oximeter or a reflective pulse oximeter, wherein both types of oximetry sensors detect blood oxygen saturation and/or heart rate.

The transmissive pulse oximeter comprises two distinct sides that are parallel with a space separating the two sides creating a measuring site such that a portion of the human body may be inserted between the two sides. The portion of the human body most often inserted in the measuring site is chosen from the group index finger, middle finger, ring finger, pinky finger, thumb, toe, ear lobe, and nose. Two light-emitting diodes (LED) are at least partially contained on the first parallel side creating an emitter. In some embodiments, the two LEDs produce beams of light at different frequencies, which include the range of about 600-750 nanometers (nm) and the range of about 850-1000 nm such that the frequencies produce red and infrared light, respectively. Additionally, the second parallel side comprises a photo detector positioned to be opposite of the emitter such that the photo detector receives the emitted light that passes through the measuring site. The photo detector determines the amount of red and infrared light received, thus determining the amount of red and infrared light absorbed. Accordingly, the amounts of red and infrared light are transmitted to the data processing unit of the connected tracker.

Optionally, the data processing unit of the connected tracker calculates the ratio of red light to infrared light after the emitted light passes through the measuring site and is received by the photo detector. The calculated ratio is compared to a data bank that relates the calculated ratio to blood oxygen saturation values. The heart rate is further determined by the amount of light absorption of the volume of arterial blood. As the heart pumps blood, the volume of arterial blood increases thus creating a pulsatile change in light absorption. The heart rate is determined by the frequency of pulsatile changes representing heart beats.

Optionally, the reflective pulse oximeter comprises one distinct side, referred to as the contact surface, that comprises both the light emitter and the photo detector such that the emitted light travels into the measuring site and is reflected back to the photo detector. The reflective pulse oximeter allows the user to contact only one surface on the implement. Accordingly, the reflective pulse oximeter may be contacted by the user during the normal operation of the toothbrush.

Accordingly, the reflective pulse oximeter transmits the amounts of red and infrared light received by the photo detector via the transmitter to the data processing unit. Similarly, the ratio of red light to infrared light is calculated and compared to a data bank to correlate the ratio to a blood oxygen saturation value. Additionally, the heart rate of the user is determined in the same manner as described for the transmissive pulse oximeter.

In some embodiments, at least a portion of the oximetry sensor is located on the body of the connected tracker such that the user contacts the oximetry sensor during normal operation of the implement. In some embodiments of the transmissive pulse oximeter, the first and second parallel sides are located on the exterior of the body of the connected tracker such that a user may contact the transmissive pulse oximeter when the connected tracker is fully assembled. In some embodiments, the two parallel sides are parallel to the exterior surface of the body. Optionally, the two parallel sides are perpendicular to the exterior surface of the body.

In some embodiments of the reflective pulse oximeter, the contact surface is positioned to be flush with the portions of the body surrounding the reflective pulse oximeter such that the body and the reflective pulse oximeter are comprised in a smooth surface. Optionally, the contact surface is positioned to be raised above the portions of the body surrounding the reflective pulse oximeter such that the reflective pulse oximeter is noticeably distinct from the portions of the handle surrounding it. Optionally still, the contact surface is positioned to be flush with the portions of the body surrounding the reflective pulse oximeter, and at least a portion of the body not directly surrounding the reflective pulse oximeter is raised such that the reflective pulse oximeter is located in at least a partial depression indicating where the user shall place his/her thumb for contact with the contact surface.

In some embodiments, the oximetry sensor may be a plurality of transmissive pulse oximeters. In some embodiments, the oximetry sensor may be a plurality of reflective pulse oximeters. Also, in some embodiments, the oximetry sensor may be a combination of at least one transmissive pulse oximeter and at least one reflective pulse oximeter.

In some embodiments, the connected tracker is comprised as the base unit in a user identification system that further comprises a mobile unit and the human body. The data processing unit of the connected tracker operates a capacitive touch sensor that constantly monitors for a touch input, such as the user holding the connected tracker. The data processing unit of the connected tracker then transmits a signal at a certain frequency to the mobile unit using the human body as a capacitive coupler. The human body's capacitance allows it to transmit signals at different frequencies simultaneously as a capacitive coupler. Additionally, the mobile unit comprises a data processing unit. The mobile unit receives the signal from the connected tracker, base unit, indicating the user is in contact with the connected tracker and transmits a response signal at a different frequency than the signal sent from the connected tracker. The response signal identifies the mobile unit using a unique identification code, thus identifying the user to the connected tracker. Since the frequencies of the two signals differ, the signals can be sent simultaneously allowing for simultaneous identification of the user.

Optionally, the mobile unit is a data transfer medium, such as a “smartphone,” comprising a data processing unit. The data transfer medium receives the signal from the connected tracker through capacitive coupling of the human body, and the data transfer medium transmits the user identification signal to the connected tracker through capacitive coupling of the human body. This configuration allows the connected tracker to identify the user via a “smartphone” the user is currently using.

Optionally, the mobile unit is a dedicated system that readily attaches to a data transfer medium and utilizes the data transfer medium's data processing unit. Accordingly, the dedicated system that readily attaches to a data transfer medium provides an interface to the human body for capacitive coupling. Optionally, the mobile unit is an activity tracker that is worn on the user's body. Optionally, the mobile unit is a wrist worn device such as a watch, bracelet, activity tracker, or any combination thereof.

Optionally, the mobile unit is a dedicated system that is used for the sole purpose of identifying the user. Optionally, the mobile unit is an embedded chip in the user's skin such that the user can consistently be identified by the connected tracker. Optionally, the mobile unit is a tattooed circuit on the user's skin such that the circuit can receive the signal from the connected tracker and transmit the user identification signal.

Furthermore, in some embodiments, the mobile unit that communicates with the connected tracker communicates with at least one other base unit such that the same mobile unit can be used with multiple base units that utilized capacitive coupling through the human body for user identification. Other base units may include scales, floss, activity trackers, refrigerators, bath mats, door handles, remote controls, computer input devices, and other various devices that require a user to touch them for proper use.

In some embodiments, the connected tracker for oral health implements including variations described herein is comprised in a system that allows a user to view and monitor the measured data via a data transfer medium, such as a “smartphone”, and/or a network storage device, often known as the “cloud” and hereinafter referred to as the Cloud. Embodiments of the connected tracker comprised in this system include the data extractor described previously. Accordingly, the system allows the connected tracker to transfer data to the data transfer medium and/or the Cloud. Additionally, the data transfer medium may transfer said data to the Cloud for display and manipulation on further data transfer mediums connected to said Cloud. Alternatively, the Cloud may transfer said data to the data transfer medium.

In some embodiments, the connected activity tracker is attached to the oral health implement using an adhesive. Optionally, the adhesive is permanently fixed to the connected activity tracker such that the activity tracker is adhered to the oral health implement. Additionally, the adhesive allows for the removal of the connected activity tracker from the oral health implement. Optionally, the adhesive is applied to both the connected activity tracker and the oral health implement. The adhesive is chosen from the group consisting of epoxy, polyurethane, cyanoacrylate, ultraviolet light curing adhesive, ethylene-vinyl acetate hot-melt adhesive, bioadhesive, and any combination thereof.

In some embodiments, the connected activity tracker is attached to the oral health implement using a fastener that is configured to mechanically join the connected activity tracker and the oral health implement. Optionally, the connected activity tracker is attached to the oral health implement using tape. Optionally, the attachment and detachment of the connected activity tracker to the oral health implement is completed using a proprietary tool.

Optionally, the connected activity tracker is mechanically joined to the oral health implement without the use of a fastener. Accordingly, the connected activity tracker comprises at least two arms extended from the body of the housing such that the arms are elastically deformed and placed around the oral health implement. Thus, the arms can be elastically deformed numerous times allowing the user to place and remove the connected activity tracker as needed.

In some embodiments, the connected activity tracker including variations described herein is comprised in a system that allows a user to view and monitor the data via a data transfer medium, such as a “smartphone”, and/or a network storage device, often known as the “cloud” and hereinafter referred to as the Cloud. Embodiments of the connected activity tracker comprised in this system include the transceiver described previously. Accordingly, the system allows the connected activity tracker to transfer data to the data transfer medium and/or the Cloud. Additionally, the data transfer medium may transfer said data to the Cloud for display and manipulation on further data transfer mediums connected to said Cloud. Alternatively, the Cloud may transfer said data to the data transfer medium.

In some embodiments, the data transfer medium comprises a transceiver, a data processing unit, and a display. Accordingly, the data processing unit is chosen from the group microprocessor, microcontroller, field programmable gate array (FPGA), digital signal processing unit (DSP), application specific integrated circuit (ASIC), programmable logic, and combinations thereof. The data processing unit comprises a collector, storage medium, and a processor.

Moreover, the storage medium of the data processing unit is comprised of volatile memory and non-volatile memory, wherein volatile memory is used for short-term storage and processing, and non-volatile memory is used for long-term storage. Accordingly, in some embodiments, volatile memory is chosen from the group random-access memory (RAM), dynamic random-access memory (DRAM), double data rate synchronous dynamic random-access memory (DDR SDRAM), static random-access memory (SRAM), thyristor random-access memory (T-RAM), zero-capacitor random-access memory (Z-RAM), and twin transistor random-access memory (TTRAM). Optionally, in some embodiments, non-volatile memory is chosen from the group read-only memory (ROM), programmable read-only memory (PROM), erasable programmable read-only memory (EPROM), electrically erasable programmable read-only memory (EEPROM), flash memory, ferroelectric random-access memory (FeRAM), magnetoresistive random-access memory (MRAM), phase-change memory (PRAM), conductive-bridging random-access memory (CBRAM), silicon-oxide-nitride-oxide-silicon memory (SONOS), resistive random-access memory (RRAM), racetrack memory, nano-random-access memory (NRAM), and Millipede memory.

Further still, the processor of the data processing unit is chosen from the group microprocessor and microcontroller.

Additionally, the transceiver of the data transfer medium is chosen from the group universal serial bus (USB), serial port, wired Ethernet port, radio frequency, microwave communication, infrared short-range communication, near field communication, Bluetooth, Wi-Fi, and any combination thereof.

Optionally, the data transfer medium is chosen from the group personal computer, tablet computer, mobile phone (i.e. “smartphone”), television, dedicated system, charging station, network router, and web-enabled server.

Additionally, the display of the data transfer medium converts signals into user-readable formats.

In some embodiments, the Cloud is connected to a network, wherein the network is chosen from the group Internet or intranet such that an intranet is a network managed and accessed by an internal organization and is not accessible to the outside world. The network is utilized by the Cloud for receiving and transmitting data. The mode for receiving and transmitting data through the network is chosen from the group universal serial bus (USB), serial port, wired Ethernet port, radio frequency, microwave communication, infrared short-range communication, near field communication, Bluetooth, Wi-Fi, and any combination thereof.

Additionally, the Cloud processes data using at least one microprocessor, at least one microcontroller, or a combination thereof. The storage of data is comprised of volatile memory and non-volatile memory, wherein volatile memory is used for short-term storage and processing, and non-volatile memory is used for long-term storage. Accordingly, volatile memory is chosen from the group random-access memory (RAM), dynamic random-access memory (DRAM), double data rate synchronous dynamic random-access memory (DDR SDRAM), static random-access memory (SRAM), thyristor random-access memory (T-RAM), zero-capacitor random-access memory (Z-RAM), and twin transistor random-access memory (TTRAM). Optionally, non-volatile memory is chosen from the group read-only memory (ROM), programmable read-only memory (PROM), erasable programmable read-only memory (EPROM), electrically erasable programmable read-only memory (EEPROM), flash memory, ferroelectric random-access memory (FeRAM), magnetoresistive random-access memory (MRAM), phase-change memory (PRAM), conductive-bridging random-access memory (CBRAM), silicon-oxide-nitride-oxide-silicon memory (SONOS), resistive random-access memory (RRAM), racetrack memory, nano-random-access memory (NRAM), and Millipede memory.

The Cloud, optionally, is a network server primarily used for storing and processing data. Optionally, the Cloud is comprised of more than one network server such that the network servers operate in conjunction to increase the storing and processing capabilities of the Cloud. Alternatively, the Cloud is provided as a service such that it is physically located at a location separate from the user, and the service provided is the storing and processing of data.

In some embodiments, the system comprising the connected activity tracker facilitates the user's participation in social games related to the data collected by the sensors of the connected activity tracker. Participation in said social games is accomplished passively through the collection of data by the sensors of the connected activity tracker over a period of time, rather than participation by real-time user input. Optionally, the social games consist of goals to be accomplished, competitive games between multiple users or between a singular user and a computer generated user, and challenges to complete specified milestones.

Participation in social games is accomplished through a plurality of different user groups. The first user group for participation is a closed loop user group, which is accomplished on a specific data transfer medium and participation is limited to the users of said specific data transfer medium. The second user group for participation is a networked user group, which is accomplished over a network that connects a plurality of data transfer mediums. Networked user groups are further defined as including users belonging to a certain group defined through social media or other means. The third user group for participation is a global user group, which is a user group that anyone can join and participate in. The global user group, in some embodiments, may be sponsored or promoted by a particular entity as a form of advertisement or incentive to the users of the global user group.

Participation in social games may be incentivized with an offered reward to encourage participation of members of a user group. Rewards may include coupons, discounts on goods or services, virtual currency, insurance discounts, and customized incentives. Rewards have the advantage of being given based off of passive data collected by sensors, thus rewarding users for health compliance and health statistics.

In some embodiments, the system and connected activity tracker provide for the user's active participation in real-time games using the connected activity tracker as a controller. Optionally, the game interface is comprised in the data transfer medium, such that it displays the interactions and provides the processing and storage means for the game. Additionally, games can encourage a user to complete proper brushing within the entire oral cavity and direct the user to move to underserved areas of the oral cavity through game interaction.

It will be understood that the embodiments described herein are not limited in their application to the details of the teachings and descriptions set forth, or as illustrated in the accompanying figures. Rather, it will be understood that a connected tracker for oral health implements, as taught and described according to multiple embodiments disclosed herein, is capable of other embodiments and of being practiced or carried out in various ways.

Also, it is to be understood that the phraseology and terminology used herein is for the purpose of description and should not be regarded as limiting. The use herein of “including,” “comprising,” “i.e.,” “containing,” or “having,” and variations of those words is meant to encompass the items listed thereafter, and equivalents of those, as well as additional items.

Accordingly, the descriptions herein are not intended to be exhaustive, nor are they meant to limit the understanding of the embodiments to the precise forms disclosed. It will be understood by those having ordinary skill in the art that modifications and variations of these embodiments are reasonably possible in light of the above teachings and descriptions.

What is claimed is:

1. A connected tracker, comprising:
a data processing unit having a storage medium that is configured to store data and at least one processor that is configured to process data;
a transceiver that is configured to receive and transmit data; and
an activity sensor that is configured to collect activity data for an oral health implement,
wherein the connected tracker is affixed to an oral health implement.

2. The connected tracker of claim 1, wherein the transceiver is chosen from the group universal serial bus (USB), serial port, wired Ethernet port, radio frequency, microwave communication, infrared short-range communication, near field communication, Bluetooth, Wi-Fi, and any combination thereof.

3. The connected tracker of claim 1, wherein the connected tracker is affixed to an oral health implement chosen from the group consisting of a toothbrush, flosser, gum massager, tongue cleaner, interdental brush, dental floss dispenser, and any combination thereof.

4. The connected tracker of claim 1, wherein the activity sensor is chosen from the group consisting of at least one accelerometer, at least one gyroscope, at least one capacitive sensor, and any combination thereof.

5. The connected tracker of claim 1, wherein the connected tracker is affixed to an oral health implement using a method chosen from the group consisting of adhesive, fastener, tape, mechanical joint, and any combination thereof.

6. The connected tracker of claim 1, further comprising at least one additional tracker chosen from the group consisting of a temperature sensor, oximetry sensor, capacitive sensor, and any combination thereof.

7. A connected tracker system, comprising:
a connected tracker having a data processing unit that is configured to store and process data, a transceiver that is configured to receive and transmit data, and an activity sensor that is configured to collect activity data for an oral health implement; and
a cloud computing network having at least one data processing unit that is configured to store and process data and a transceiver that is configured to receive and transmit data,
wherein the connected tracker is affixed to an oral health implement.

8. The connected tracker system of claim 7, further comprising a data transfer medium having a transceiver that is configured to receive and transmit data, a data processing unit that is configured to store and process data, and a display that is configured to show data.

9. The connected tracker system of claim 8, wherein the data transfer medium further comprises a user interface that is configured to facilitate participation in social games such that participation is accomplished passively through data collection of the connected activity tracker over a period of time.

10. The connected tracker system of claim 8, wherein the data transfer medium further comprises a user interface that is configured to facilitate active participation in games, wherein the connected tracker is a game controller.

11. The connected tracker system of claim 8, wherein the data is configured to create user health ratings that are configured to affect at least one chosen from the group consisting of insurance underwriting, risk modeling, diagnostic decisions, health procedure determination, health outcomes, provider offered services, access to a health benefit, access to an insurance product, health care costs, health benefit incentives, and any combination thereof.

12. A connected tracker system, comprising:
a connected tracker having a data processing unit that is configured to store and process data, a transceiver that is configured to receive and transmit data, and an activity sensor that is configured to collect activity data for an oral health implement; and
a mobile unit having a data processing unit that is configured to store and process data and communicate with the toothbrush via capacitive coupling,
wherein both the connected tracker and the mobile unit are in contact with the human body such that the human body acts as a capacitive coupler and is arranged to allow for the transmission of at least one signal.

13. The connected tracker system of claim 12, wherein the connected tracker is configured to transmit a signal at a frequency that is different than frequency of the signal that the mobile unit is configured to transmit.

14. The connected tracker system of claim 13, wherein the connected tracker and mobile unit are configured to transmit signals simultaneously.

15. The connected tracker system of claim 12, wherein the connected tracker is configured to transmit a signal to the mobile unit when a touch input is detected.

16. The connected tracker system of claim 15, wherein the mobile unit is configured to transmit a response signal to the connected tracker.

17. The connected tracker system of claim 16, wherein the response signal further comprises at least one identification code.

18. The connected tracker system of claim 12, wherein the mobile unit is comprised in a data transfer medium.

19. The connected tracker system of claim 12, wherein the mobile unit is comprised in a dedicated system that is configured to detachably connect to a data transfer medium having at least one data processing unit and is configured to utilize the data processing unit of the data transfer medium.

20. The connected tracker system of claim 12, wherein the mobile unit is configured to communicate with additional base units.
